(19) United States
(12) Patent Application Publication
(10) Pub. No.: US 2023/0180310 A1
(43) Pub. Date: Jun. 8, 2023

(54) TECHNIQUES FOR ACCELERATING DATA RECOVERY FROM OUT OF SERVICE

(71) Applicant: QUALCOMM Incorporated, San Diego, CA (US)

(72) Inventors: Ying WANG, Beijing (CN); Chaofeng HUI, Beijing (CN); Zhiguo LI, Beijing (CN); Nan ZHANG, Beijing (CN); Yongjun XU, Beijing (CN)

(21) Appl. No.: 17/997,474

(22) PCT Filed: Jul. 2, 2020
(86) PCT No.: PCT/CN2020/099873

§ 371 Date: Oct. 28, 2022

(51) Int. Cl. H04W 76/10; H04W 40/22; H04W 60/04; H04W 48/18

(52) U.S. Cl. CPC H04W 76/10; H04W 40/22; H04W 60/04; H04W 48/18

(57) ABSTRACT

Methods, systems, and devices for wireless communications are described. In some systems, a user equipment (UE) may attempt to establish a data session with a base station. The UE may transmit one or more session request messages including one or more route selection descriptors (RSDs) to the base station, and the UE may determine a successful RSD that may be compatible with the network based on a session accept message received from the base station. The UE may store the successful RSD at a location in memory for use in future session establishment procedures. For example, the UE may go out of service, and may re-acquire service with the same network. In such cases, the UE may transmit a session request message including the previously-accepted RSD to re-establish a data session with the base station.

### CROSS REFERENCE

The present Application is a 371 national stage filing of International PCT Application No. PCT/CN2020/099873 by Wang et al. entitled “TECHNIQUES FOR ACCELERATING DATA RECOVERY FROM OUT OF SERVICE,” filed Jul. 7, 2020, which is assigned to the assignee hereof, and which is expressly incorporated by reference in its entirety herein.

### FIELD OF TECHNOLOGY

The following relates generally to wireless communications and more specifically to techniques for accelerating data recovery from out of service.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a UE may attempt to establish a data session with a network. To establish the data session, the UE may cycle through a set of route selection descriptors (RSDs) until the UE uses an RSD that is accepted by the network. In some cases, however, such iteration over the set of RSDs may result in increased latency.

### SUMMARY

The described techniques relate to improved methods, systems, devices, and apparatuses that support techniques for accelerating data recovery from out of service (OOS). Generally, the described techniques provide for storing a previously-accepted route selection descriptor (RSD) for use in future session establishment requests. For example, a user equipment (UE) may use a set of RSDs to establish a data session for communicating with a cell (e.g., a base station). During a session establishment procedure, the UE may transmit one or more session request messages to the cell, where each session request message may include a different RSD from the set of RSDs. The session request messages may be transmitted until the cell transmits a session accept message responsive to one of the session request messages. The RSD included in the accepted session request message may be referred to as a successful RSD because the RSD may include a number of components allowable by the cell (e.g., based on available resources). Based on the received session accept massage, the UE may store the successful RSD in a location of memory for use in future session establishment requests with the same network. For example, the UE may attempt to re-establish a data session with a network, for example, after going OOS, and the UE may transmit a session establishment request after re-acquiring service with the network. In some examples, the UE may use a previously-accepted RSD that is stored at the UE for the session establishment request, which may be based on a determination that the network remained the same after re-acquiring service. As such, the UE may refrain from repeatedly transmitting session request messages including different RSDs from the set of RSDs to re-establish the data session with the network. Instead, the UE may use the RSD that was determined to be a successful RSD without transmitting other RSDs known to have been previously rejected by the network.

A method of wireless communication at a UE is described. The method may include transmitting a first session establishment request message to a cell, the first session establishment request message indicating a first RSD from a set of RSDs, receiving, in response to the first session establishment request message, a session establishment accept message from the cell based on an acceptance of the first RSD, storing the first RSD based on the received session establishment accept message, and transmitting, after going out of service with the cell, a second session establishment request message to the cell, the second session establishment request message indicating the stored first RSD, where the second session establishment request message is transmitted based on reacquiring service with the cell.

An apparatus for wireless communication at a UE is described. The apparatus may include a processor, memory coupled with the processor, and instructions stored in the memory. The instructions may be executable by the processor to cause the apparatus to transmit a first session establishment request message to a cell, the first session establishment request message indicating a first RSD from a set of RSDs, receive, in response to the first session establishment request message, a session establishment accept message from the cell based on an acceptance of the first RSD, store the first RSD based on the received session establishment accept message, and transmit, after going out of service with the cell, a second session establishment request message to the cell, the second session establishment request message indicating the stored first RSD, where the second session establishment request message is transmitted based on reacquiring service with the cell.

Another apparatus for wireless communication at a UE is described. The apparatus may include means for transmitting a first session establishment request message to a cell, the first session establishment request message indicating a first RSD from a set of RSDs, receiving, in response to the first session establishment request message, a session establishment accept message from the cell based on an acceptance of the first RSD, storing the first RSD based on the received session establishment accept message, and transmitting, after going out of service with the cell, a second session establishment request message to the cell, the second session establishment request message indicating the stored first RSD, where the second session establishment request message is transmitted based on reacquiring service with the cell.

A non-transitory computer-readable medium storing code for wireless communication at a UE is described. The code may include instructions executable by a processor to transmit a first session establishment request message to a cell, the first session establishment request message indicating a first RSD from a set of RSDs, receive, in response to the first session establishment request message, a session establishment accept message from the cell based on an acceptance of the first RSD, store the first RSD based on the received session establishment accept message, and transmit, after going out of service with the cell, a second session establishment request message to the cell, the second session establishment request message indicating the stored first RSD, where the second session establishment request message is transmitted based on reacquiring service with the cell.

Some examples of the method, apparatuses, and non-transitory computer-readable medium described herein may further include operations, features, means, or instructions for determining whether a core network remains the same when reacquiring service with the cell, where transmitting the second session establishment request message indicating the stored first RSD may be based on a determination that the core network may be the same when service may be reacquired.

Some examples of the method, apparatuses, and non-transitory computer-readable medium described herein may further include operations, features, means, or instructions for starting a timer based on storing the first RSD, and determining whether the core network remains the same based on an expiration of the timer.

Some examples of the method, apparatuses, and non-transitory computer-readable medium described herein may further include operations, features, means, or instructions for determining that the core network remains the same based on service being reacquired prior to the expiration of the timer, where the second session establishment request message indicating the stored first RSD may be transmitted prior to the expiration of the timer.

Some examples of the method, apparatuses, and non-transitory computer-readable medium described herein may further include operations, features, means, or instructions for determining that the core network may have changed based on service being reacquired after the expiration of the timer, and transmitting a third session establishment request message indicating a second RSD from the set of RSDs, the second RSD being different from the first RSD.

Some examples of the method, apparatuses, and non-transitory computer-readable medium described herein may further include operations, features, means, or instructions for determining a configuration of the timer, where a duration of the timer may be based on the configuration.

In some examples of the method, apparatuses, and non-transitory computer-readable medium described herein, the configuration may be based on an operator deployment for the core network.

Some examples of the method, apparatuses, and non-transitory computer-readable medium described herein may further include operations, features, means, or instructions for identifying, prior to going out of service with the cell, a first registration area code and a first node identifier associated with a first network node, and receiving, when reacquiring service with the cell, a registration acceptance message that includes an indication of a second registration area code and a second node identifier, where determining that the core network remains the same may be based on the first registration area code being the same as the second registration area code and the first node identifier being the same as the second node identifier.

In some examples of the method, apparatuses, and non-transitory computer-readable medium described herein, the first session establishment request message and the second session establishment request message may be for a same application, a same subscription, or both.

Some examples of the method, apparatuses, and non-transitory computer-readable medium described herein may further include operations, features, means, or instructions for transmitting, prior to the first session establishment request message, one or more session establishment request messages, each session establishment request message of the one or more session establishment request messages indicating another RSD from the set of RSDs that may be different from the first RSD, and receiving, in response to each session establishment request message of the one or more session establishment request messages, a session establishment rejection messages based on the other RSDs.

In some examples of the method, apparatuses, and non-transitory computer-readable medium described herein, the first RSD may include an RSD precedence, route selection components, a session and service continuity mode selection, network slice selection assistance information, a data network name selection, a protocol data unit (PDU) session type selection, a non-seamless offload indication, an access type preference, or any combination thereof.

In some examples of the method, apparatuses, and non-transitory computer-readable medium described herein, the first session establishment request message and the second session establishment request message may include a PDU session establishment request message.

### BRIEF DESCRIPTION OF THE DRAWINGS

FIG. 1 illustrates an example of a system for wireless communications that supports techniques for accelerating data recovery from out of service in accordance with aspects of the present disclosure.

FIG. 2 illustrates an example of a wireless communications system that supports techniques for accelerating data recovery from out of service in accordance with aspects of the present disclosure.

FIG. 3 illustrates an example of a process flow in a system that supports techniques for accelerating data recovery from out of service in accordance with aspects of the present disclosure.

FIGS. 4 and 5 show block diagrams of devices that support techniques for accelerating data recovery from out of service in accordance with aspects of the present disclosure.

FIG. 6 shows a block diagram of a communications manager that supports techniques for accelerating data recovery from out of service in accordance with aspects of the present disclosure.

FIG. 7 shows a diagram of a system including a device that supports techniques for accelerating data recovery from out of service in accordance with aspects of the present disclosure.

FIGS. 8 through 11 show flowcharts illustrating methods that support techniques for accelerating data recovery from out of service in accordance with aspects of the present disclosure.

### DETAILED DESCRIPTION

In some wireless communications systems, a network (e.g., a 5G core (5GC) network) and a user equipment (UE) may communicate data by establishing a data session. For example, to access an Internet protocol (IP) multimedia subsystem (IMS), the Internet, video, or other network slice, the UE may first attempt to establish a data session with the network (e.g., via a base station) for a particular application using a session establishment procedure (e.g., a protocol data unit (PDU) session establishment procedure). In such session establishment procedures, the UE may transmit one or more session request messages to the base station, each session request message including a different route selection descriptor (RSD). The RSD may include various information regarding the data session the UE is attempting to establish for the application, including an indication of a session and service continuity (SSC) mode, network slice information, a PDU session type, an access type, or the like. In some cases, the UE may select, for each session request message, a different RSD from a set of RSDs stored at the UE, where each RSD may include different parameters. The UE may transmit session request messages including different (e.g., sequentially selected) RSDs until the UE receives a session accept message from the base station responsive to one of the session request messages. Upon reception of the session accept message, the UE may establish the data session and communicate with the base station accordingly.

In some cases (e.g., such as when the UE goes out of service (OOS), then re-acquires service with the network), the UE may attempt to re-establish a data session with the network. For example, the UE may re-acquire service with the network, and the UE may attempt to re-establish the data session with the network via the base station for the same application by sending one or more session request messages, each session request message again including a different RSD from the set of RSDs. However, in some cases, the RSDs included in the UE's session request messages when re-acquiring service may include RSDs that were previously rejected by the network. More specifically, when the UE initially established the data session with the network (e.g., prior to going OOS), one or more RSDs may be rejected by the network (such as when the requested resources may not be available, when an SSC mode isn't support, and so forth). When the UE goes back in service, the UE may re-transmit the same RSDs that were previously rejected, meaning that the UE may again cycle through multiple RSDs until the successful RSD is included in a session request message. Such duplication of the session establishment procedure after re-acquiring service may be inefficient and may result in increased latency or unnecessary processing at the UE, or both.

As described herein, the UE may store one or more previously-accepted RSDs for use in future session establishment procedures with the same network and/or for the same application. For example, upon reception of a session accept message indicating that a first RSD is accepted by the network, the UE may store the first RSD at a location in memory. In some examples, the memory location may be different from a location used to store the set of RSDs. By storing the previously-accepted RSD, the UE may avoid repeating duplicative processes in the case that the UE re-acquires service with the same network. As an illustrative example, the UE may receive a session accept message from a base station responsive to transmitting a session request including a first RSD, and the UE may store the first RSD according to the session accept message. The UE may go OOS and subsequently re-acquire service with the same network (e.g., the UE may enter an elevator), and the UE may use the first RSD for transmitting a session request message to the base station. Such techniques may reduce latency, and improve the success rate of the data session establishment procedure because the first RSD may have previously been accepted by the same network.

In some implementations, the described techniques may enable a UE to determine if the network remained the same after re-acquiring service. In one example, the UE may start a timer based on receiving a session accept message from the network and storing the associated RSD. The UE may determine if the network remained the same after re-acquiring service according to the timer (e.g., if the timer has not expired when re-acquiring service, the UE may determine that the network has not changed). In another example, the UE may determine if the network remained the same according to identification information associated with the network (e.g., a node identifier (ID), an AMF ID, a registration area code, or the like). The UE may transmit a session request message including a previously-accepted RSD stored at the UE if the UE determines that the network remained the same.

Particular aspects of the subject matter described herein may be implemented to realize one or more potential advantages. By streamlining the session establishment procedure after re-acquiring service with a same network based on storing an RSD that was previously determined to be a successful RSD, the UE may spend fewer resources attempting to establish the data session and more time communicating data with the base station, which may result in reduced overhead, reduced latency, greater spectral efficiency, and higher data throughput.

Aspects of the disclosure are initially described in the context of wireless communications systems. Aspects of the disclosure are additionally described in the context of a process flow. Aspects of the disclosure are further illustrated by and described with reference to apparatus diagrams, system diagrams, and flowcharts that relate to techniques for accelerating data recovery from out of service.

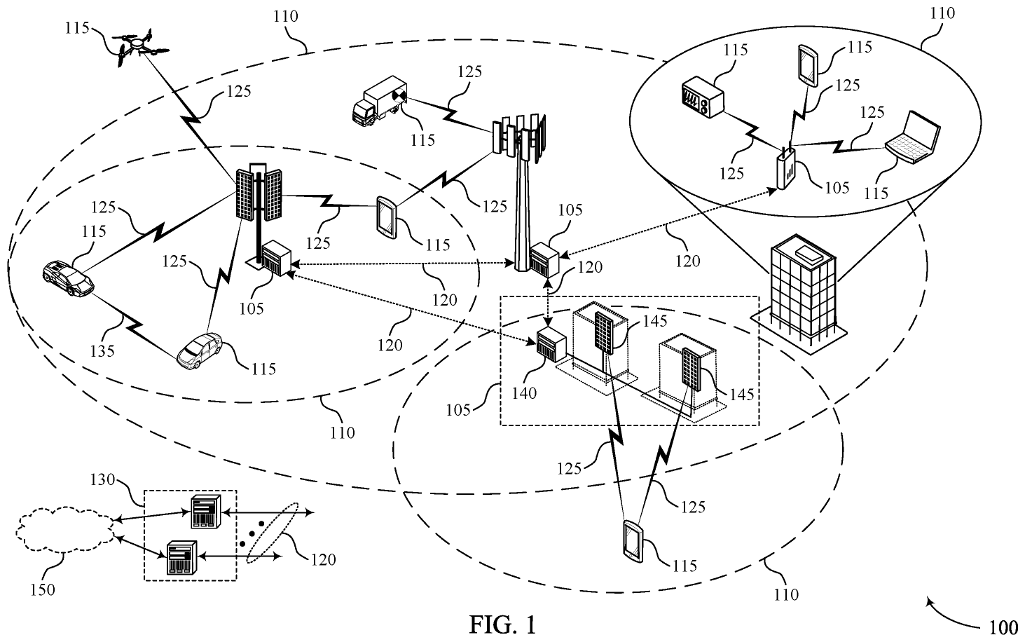

FIG. 1 illustrates an example of a wireless communications system 100 that supports techniques for accelerating data recovery from out of service in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof. In some examples, the wireless communications system 100 may support the storage of previously-accepted RSDs for use in session establishment procedures by a UE 115.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers. In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5GC, which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IMS, or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example, in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some cases, a UE 115 may attempt to establish a data session, such as a PDU session, with a core network (e.g., 5GC) via a base station 105 for a particular application. To establish the data session, the base station 105 and the UE 115 may participate in a session establishment procedure. In such session establishment procedures, the UE 115 may transmit one or more session request messages to the base station 105, each session request message including a different RSD. In some cases, the UE 115 may select, for each session request message, a different RSD from a set of RSDs stored at the UE 115. The UE 115 may transmit one or more session request messages including different RSDs until the base station 105 transmits a session accept message to the UE 115 responsive to one of the session request messages. Upon reception of the session accept message, the UE 115 may establish the data session and communicate with the base station 105 accordingly.

In some cases (e.g., such as when the UE 115 goes OOS, then re-acquires service with the network), the UE 115 may attempt to re-establish a data session in a network (e.g., the core network 130). For example, the UE 115 may re-acquire service with the network, and may attempt to re-establish the data session with the base station 105 (e.g., for a same application) by sending one or more session request messages to the base station 105. Similar to when the UE 115 initially established the data session, each session request message may include a different RSD from the set of RSDs stored at the UE 115. As such, the UE 115 may transmit session request messages including different RSDs until the UE 115 receives a session accept message from the base station 105 responsive to one of the session request messages. Such duplication of the session establishment procedure after re-acquiring service may result in high latency or unnecessary processing at the UE 115, or both.

In the wireless communications system 100, the UE 115 may store one or more previously-accepted RSDs for use in future session establishment procedures with the same network and/or for the same application. For example, upon reception of a session accept message indicating a first RSD may be compatible with the network, the UE 115 may store the first RSD at a location in memory different from the location used to store the set of RSDs. As an illustrative example, the UE 115 may receive a session accept message from a base station 105 responsive to transmitting a session request including a first RSD, and the UE 115 may store the first RSD according to the session accept message. The UE 115 may go OOS and subsequently re-acquire service with the same network (e.g., the UE 115 may enter an elevator), and the UE 115 may re-acquire service with the network by transmitting a session establishment request message including the stored RSD (e.g., that was accepted by the same network). That is, the UE 115 may use the first RSD for transmitting a session request message to the base station 105. As such, the UE 115 may avoid repeating a duplicate process (e.g., re-transmitting previously-rejected RSDs) in the case that the UE 115 re-acquires service with the same network. Such techniques may reduce latency, and improve the success rate of the data session establishment procedure because the first RSD may have previously been accepted by the same network.

The UE 115 may transmit a session request message to the base station 105 according to a determination that the network remained the same after re-acquiring service. In one example, the UE 115 may start a timer responsive to receiving a session accept message from the network and storing the associated RSD. The UE 115 may determine if the network remained the same after re-acquiring service according to the timer. In another example, the UE 115 may determine if the network remained the same according to identification information associated with the network (e.g., a node identifier (ID), an AMF ID, a registration area code, or the like). By streamlining the session establishment procedure after re-acquiring service with a same network based on storing an RSD that was previously determined as a successful RSD, the UE 115 may spend less resources attempting to establish the data session with the base station 105 and more time communicating data with the base station 105, which may result in reduced overhead, greater spectral efficiency, and higher data throughput.

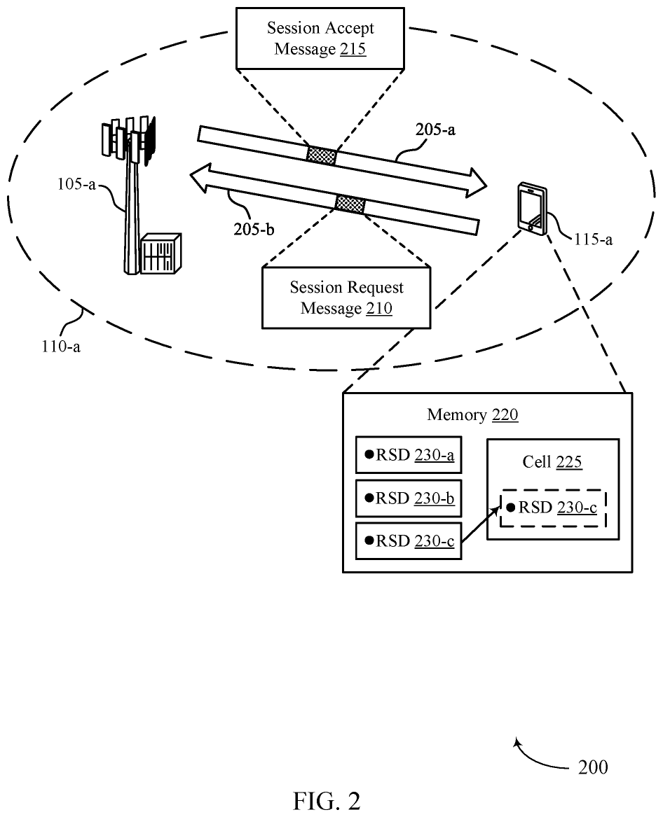

FIG. 2 illustrates an example of a wireless communications system 200 that supports techniques for accelerating data recovery from out of service in accordance with aspects of the present disclosure. In some examples, the wireless communications system 200 may implement aspects of wireless communications system 100. The wireless communications system 200 may include a base station 105-a and a UE 115-a, which may be examples of the corresponding devices described with reference to FIG. 1. Base station 105-a and UE 115-a may communicate within a geographic coverage area 110-a and over a communication link 205, which may include a downlink communication link 205-a and an uplink communication link 205-b. In some implementations of the present disclosure, UE 115-a may store a set of RSDs 230 (e.g., RSD 230-a, RSD 230-b, RSD 230-c) in memory 220. Additionally or alternatively, UE 115-a may store a successful RSD 230, such as RSD 230-c, in a memory cell 225 for use in a future session establishment procedure with a network cell (e.g., if the UE 115-a goes OOS, then subsequently reconnects to the network).

As described herein, UE 115-a may attempt to establish a data session (e.g., a PDU session) with a network (e.g., 5GC) via a cell associated with base station 105-a based on a session establishment procedure. In some examples, UE 115-a may attempt to establish a data session to communicate data between base station 105-a and UE 115-a. For example, UE 115-a may transmit one or more session request messages 210 (e.g., one or more PDU session establishment request messages) to base station 105-a. Each of the session request messages 210 may be transmitted for establishing a data session for a same application and/or a same subscription associated with UE 115-a. Each of the session request messages 210 may include a session establishment parameter, which may be configured in accordance with an RSD 230. Such configuration of the session parameter in accordance with a selected RSD 230 may be described herein as transmitting a session request message 210 including an RSD 230. The session request message 210 may additionally or alternatively be referred to as a session establishment request message, a PDU session establishment request message, or other like terminology.

Each RSD 230 stored at UE 115-a and/or included in a session request message 210 may include a number of components associated with a data session establishment procedure with base station 105-a. For example, an RSD 230 may include one or more of an RSD precedence, route selection components, an SSC mode selection, network slice selection assistance information (NSSAI), a data network name (DNN) selection, a PDU session type selection, a non-seamless offload indication, or an access type preference. In some examples, each of the components included in each RSD 230 may be configured according to a UE route selection policy (URSP). The URSP may be configured via a subscriber identity module (SIM) card and/or may be stored in memory 220 of UE 115-a. Additionally or alternatively, the URSP may be configured by the network. In some examples, the URSP from the network, from the SIM card, or from memory 220 of UE 115-a may have different priorities, and UE 115-a may use the RSDs 230 based, in part, on the URSP priorities. As an example, a URSP from the network may have a relatively higher priority than a URSP from the SIM card, and the URSP from the SIM card may have a relatively higher priority than a URSP stored (e.g., pre-stored or pre-configured) in memory 220 of UE 115-a.

In some cases, the set of RSDs 230 associated with UE 115-a may be configured at the UE 115-a (e.g., according to a URSP). Additionally or alternatively, UE 115-a may update the set of RSDs 230 based on signaling from base station 105-a (e.g., add to the set, remove from the set, or move to a memory cell 225 according to a URSP). For example, base station 105-a may signal one or more RSDs 230 that base station 105-a may allow (e.g., RSDs 230 including components which may be compatible with base station 105-a) to UE 115-a, and UE 115-a may store the accepted one or more RSDs 230 at memory cell 225, to enable UE 115-a to successfully establish a data session with base station 105-a. In some cases, base station 105-a may signal one or more RSDs 230 to UE 115-a based on UE 115-a entering or being within the geographic coverage area 110-a (e.g., different RSDs 230 may be allowable in different geographic locations, such as in different cities or in different countries).

UE 115-a may cycle through different RSDs 230 when transmitting the one or more session request messages 210. For example, UE 115-a may transmit a first session request message 210 including a first RSD 230-a. In some cases, base station 105-a may reject RSD 230-a (e.g., base station 105-a may reject one or more components of the first RSD 230-a), and base station 105-a may transmit a session reject message to UE 115-a in response to receiving the session request message 210. Accordingly, UE 115-a may transmit a second (e.g., a subsequent) session request message 210 to base station 105-a including a second RSD 230-b. In some examples, base station 105-a may reject the second RSD 230-b and may transmit another session reject message to UE 115-a responsive to receiving the second session request message 210 including the second RSD 230-b. UE 115-a may continue such transmissions of the session request message 210 including different RSDs 230 (e.g., UE 115-a may cycle through the set of RSDs 230 stored at the memory 220) until UE 115-a transmits a session request message 210 including a successful RSD 230. For example, UE 115-a may transmit a third session request message 210 to base station 105-a including RSD 230-c. In some aspects, base station 105-a may accept RSD 230-c (e.g., RSD 230-c may be a successful RSD 230) of the third session request message 210, and base station 105-a may transmit a session accept message 215 to UE 115-a responsive to receiving the third session request message 210 including the successful RSD 230-c. Accordingly, base station 105-a may grant data service to UE 115-a, and a data session between base station 105-a and UE 115-a may begin. Such cycling through the set of RSDs 230 until a successful RSD 230 is identified may be referred to as a negotiation between base station 105-a and UE 115-a for RSD 230 components.

As described herein, UE 115-a may store one or more successful RSDs 230 (e.g., RSDs 230 that may include components that may be compatible with base station 105-a and/or an associated core network for a particular application) for use in future session establishment requests. In some cases, previously-accepted RSDs 230 may be stored in a particular location in memory 220 (e.g., memory cell 225), which may be used for efficient retrieval of RSDs 230. For example, UE 115-a may receive an acceptance of RSD 230-c in a session accept message 215, and UE 115-a may store the successful RSD 230-c in memory cell 225. In some example, the stored RSD 230 (e.g., RSD 230-c) may be associated with an application, and different RSDs 230 may be stored for different applications. UE 115-a may use the successful RSD 230-c for subsequent session establishment procedures with the same network (e.g., the same network serving cell or one or more other cells associated with the same core network). UE 115-a may refrain from sequentially cycling through the set of RSDs 230 by storing each accepted RSD 230 in memory cell 225 (e.g., UE 115-a may use less time and/or fewer resources to re-connect to the network). Put another way, because UE 115-a is aware of which RSD 230 was previously successful when establishing a data session (e.g., for an application), UE 115-a may send a session request message 210 with the corresponding RSD 230 (e.g., RSD 230-c) and may avoid cycling through one or more RSDs 230 that were previously rejected by the network (e.g., RSD 230-a and RSD 230-b).

As an illustrative example, UE 115-a may attempt to re-establish a data session in a network after going OOS. UE 115-a may transmit a session request message 210 including a previously-accepted RSD 230 if UE 115-a determines that the network has remained the same when reacquiring service with the cell (e.g., the same base station 105, coverage area 110, network cell, and/or core network). In some examples, UE 115-a may start a timer (e.g., timer_preRSD) upon receiving an acceptance of an RSD 230 and storing the accepted RSD 230. UE 115-a may use the previously-accepted RSD 230 if UE 115-a is transmitting a session request message 210 prior to the expiration of the timer. The timer may be configured by UE 115-a. In some examples, the timer may be configured based on one or more parameters associated with a network cell serving UE 115-a (e.g., timing information associated with a network cell and/or dimensions of a network cell indicated by a network operator). For example, UE 115-a may store an accepted RSD 230-c, and UE 115-a may start a timer (e.g., a 1-minute timer, 5-minute timer, or 10-minute timer) that may be configured based on parameters associated with the features of a network and/or a network operator (e.g., the dimensions of a network, the time it may take for a device to exit network coverage, a number of base stations associated with the network, or the like). In one example, a first network and/or network operator that may be associated with relatively more base stations 105 than another network, and the first network may according be associated with a timer that is configured with a different duration (e.g., relatively longer) as compared to a timer for the other network. Additionally or alternatively, a first network operator may be associated with a network of different dimensions (e.g., relatively smaller dimensions) as compared to another network operator, and the UE may accordingly configure a timer with a relatively shorter duration corresponding to the first network operator. In some examples, UE 115-a may determine that a previously-accepted RSD 230-c, stored in memory cell 225, may not be used to transmit a session request message 210 to base station 105-a based on the timer expiring (e.g., UE 115-a may determine that the core network may not have remained the same).

Additionally or alternatively, UE 115-a may determine to use an accepted RSD 230 stored in memory cell 225 according to identification information associated with the network (e.g., a node identifier (ID), an AMF ID, a registration area code, or the like). For example, UE 115-a may identify identification information such as a node ID and/or a registration area code associated with the network serving UE 115-a prior to going OOS. UE 115-a may attempt to reacquire service with the network cell by transmitting a registration request message, and UE 115-a may receive a registration acceptance message including the network identification information. UE 115-a may compare the network identification information received in the registration acceptance message with the network identification information identified prior to going OOS to determine if the network may have remained the same. In cases where the network is the same, UE 115-a may transmit a session request message 210 including a stored RSD 230 (e.g., RSD 230-c) based on the determination that the network remained the same (e.g., RSD 230-c may have been previously accepted by the same network).

Using the described techniques, a UE 115 may improve the rate of successful data session establishments, and/or may reduce latency by storing accepted RSDs 230 for use in subsequent session establishment requests with the same network. The UE 115 may determine the network remained the same based on network identification information and/or a timer associated with the UE 115 (e.g., based on the mobility of the UE 115 while OOS). For example, after regaining a connection to the network, UE 115-a may refrain from transmitting one or more session request messages 210 including RSDs 230-a and 230-b (e.g., RSDs 230 which may be incompatible with base station 105-a) and may instead use the previously-accepted RSD 230-c stored in memory cell 225.

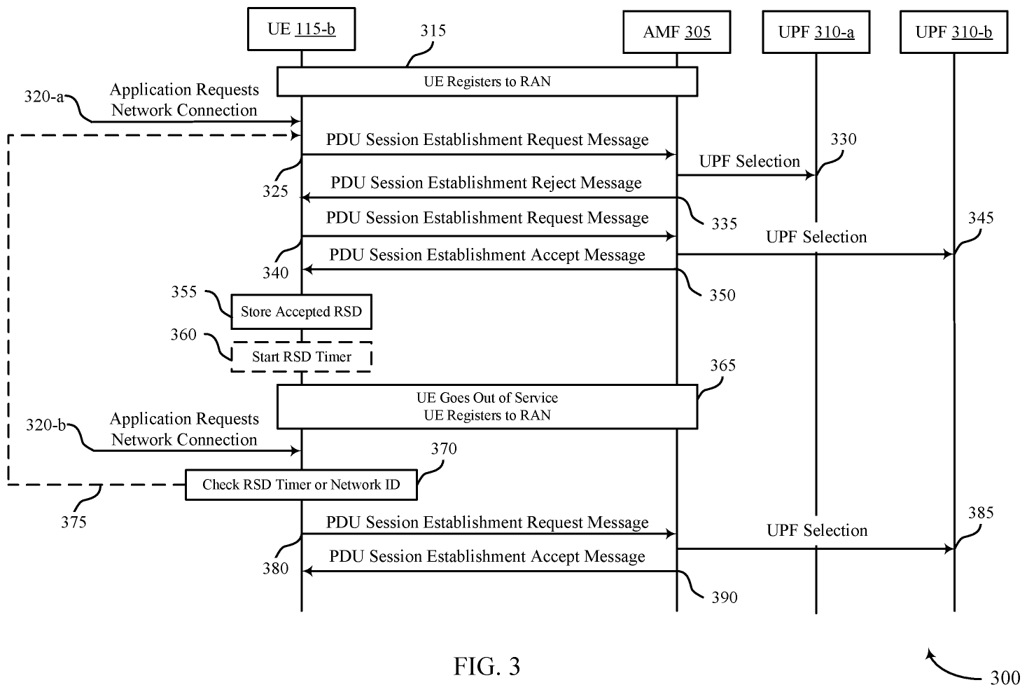

FIG. 3 illustrates an example of a process flow 300 in a system that supports techniques for accelerating data recovery from out of service in accordance with aspects of the present disclosure. In some examples, the process flow 300 may implement aspects of wireless communications system 100 and wireless communications system 200. The process flow 300 illustrates communications between a UE 115-b, an AMF 305, a UPF 310-a, and a UPF 310-b, which may be examples of corresponding devices or components of devices described herein. For example, AMF 305 and UPFs 310-a and 310-b may be examples of network nodes or network functions, and AMF 305 and UPFs 310-a and 310-b may further be examples of control plane entities and user plane entities, respectively, associated with the core network 130, as described with reference to FIG. 1. It is understood that the devices and nodes described by the process flow 300 may communicate with or be coupled with other devices or nodes that are not illustrated. For instance, UE 115-b may communicate with AMF 305 via one or more base stations 105. As another example, AMF 305 may communicate with one or more SMFs for transmitting session management requests via an interface. In some implementations, UE 115-b may store a selected RSD for use in future session establishment requests based on a session establishment procedure with a core network (e.g., a core network 130, as described with reference to FIG. 1).

At 315, UE 115-b may register to the network (e.g., a 5G or NR radio access network (RAN)). For example, UE 115-b may acquire service with a network cell (e.g., provided by a base station 105) and may register with the network via AMF 305. In some aspects, AMF 305 may be a control plane entity associated with the network. For example, AMF 305 may manage access and mobility for the network. UE 115-b may receive a registration accept message from the network (e.g., responsive to a registration request message) indicating the registration with the network. The registration accept message may include one or more of an AMF ID, a node ID and/or a registration area code associated with the network.

At 320-a, UE 115-b may receive a request from an application for a network connection. In response to the application requesting a network connection, UE 115-b may attempt to establish a data session (e.g., a PDU session) with the network. As such, at 325, UE 115-b may transmit a first session request message including a first RSD. The session request message may initiate a session establishment procedure for communicating with the network, as described herein, including with reference to FIG. 2. In some implementations, the session may be a PDU session and the session request message may be referred to as a PDU session establishment request message.

In some examples, the first RSD may be one of a set (e.g., an ordered set according to a URSP) of RSDs stored at the memory associated with UE 115-b. Each RSD may include a set of components. For example, the first RSD may include one or more of an RSD precedence, route selection components, an SSC mode selection, NSSAI, a DNN selection, a PDU session type selection, a non-seamless offload indication, or an access type preference. In one example, a first RSD may include components such that SSC MODE=1, NSSAI=enhanced mobile broadband (eMBB) 1, and DNN=Internet, and a second RSD may include components such that SSC MODE=3, NSSAI=eMBB 3, and DNN=Internet. One or more of the components included in each RSD may be compatible with a network.

At 330, AMF 305 may select UPF 310-a according to one or more of the components associated with the first RSD transmitted in the first session request message at 325. For example, the first RSD may map to UPF 310-a. In some cases, UPF 310-a may perform traffic routing functions (e.g., routing data packets to and/or from the core network). UPF 310-a may be a user plane entity associated with the network. In some examples, UPF 310-a may transfer user IP packets, provide IP address allocation and/or connect to network operators. However, in some examples, the RSD included in the first session request message may not be successful for establishing the data session. For instance, there may be insufficient resources for a network slice and DNN corresponding to the components of the RSD (e.g., associated with an NSSAI of the RSD). Additionally or alternatively, the SSC mode associated with the RSD may not be supported, or there may be insufficient resources for a specific network slice. In some examples, UE 115-b may sequentially cycle through the set of RSDs, and may transmit multiple session request messages including each of the RSDs.

At 335, AMF 305 may transmit a session reject message to UE 115-b. The session reject message may be transmitted according to one or more of the components of the first RSD. For example, one or more of the components of the first RSD may be incompatible with the network (e.g., may be incompatible with AMF 305, UPF 310-a, and/or the core network). In some examples, AMF 305 may receive multiple session requests from UE 115-b including one or more RSDs. AMF 305 may select one or more UPFs 310, and may transmit one or more session reject messages according to the components of each of the RSDs, which may be incompatible with the network.

At 340, UE 115-b may transmit a second session request message including a second RSD. The second session request message may be for a same subscription and/or a same application as the first session request message. In some cases, the second RSD may be an RSD subsequent to the first RSD in the set of RSDs stored at the memory of UE 115-b. The second RSD may include one or more components, which may have values different from one or more of the components of the first RSD.

At 345, AMF 305 may select UPF 310-b according to one or more of the components associated with the second RSD. For example, the second RSD may map to UPF 310-b. In some cases, UPF 310-b may perform traffic routing functions, and may be a user plane entity associated with the network, as described with reference to UPF 310-a. In some examples, the RSD included in the second session request message may be successful, and the data session may be established using UPF 310-b

As such, at 350, AMF 305 may transmit a session accept message to UE 115-b. The session accept message may indicate that the one or more components of the second RSD may be compatible with the network. In some cases, the session accept message may indicate that the second RSD is accepted by the network.

At 355, UE 115-b may store the accepted RSD based on the session accept message. In some examples, UE 115-b may store the accepted RSD in one or more memory cells of UE 115-b. The accepted RSD may be stored for use in future session establishment procedures with the same network.

At 360, in some implementations, UE 115-b may optionally start a timer (e.g., timer_preRSD) in accordance with the storage of the accepted RSD at 355. The timer may be configured by UE 115-b. In some examples, the duration of the timer may be configured based on configuration information received from a network operator. For example, UPF 310-b may communicate, to AMF 305 and/or UE 115-b, configuration information indicating one or more parameters associated with a network cell serving UE 115-b (e.g., timing information associated with a network cell and/or dimensions of a network cell as indicated by a network operator). In one example, the duration of the timer may be configured to 10 minutes, according to information from a network operator indicating it may take 10 minutes for a device to exit the network cell. The timer may, however, have other durations, and the present example is provided for illustrative purposes and should not be considered limiting.

At 365, UE 115-b may go OOS with the network and may subsequently re-register with the network via AMF 305. In one example, UE 115-b may enter an elevator and go OOS temporarily before attempting to re-acquire service with the network. In other examples, UE 115-b may be in motion and may enter a tunnel (or other structure) that may cause UE 115-b to go OOS, where UE 115-b may reacquire service when exiting the tunnel. UE 115-b may go OOS for some period of time for various other reasons. When registering with the network (e.g., transmitting a registration request), UE 115-b may receive a registration accept message that includes identification information including an AMF ID, registration area code, and the like.

In response to the application requesting a network connection at 320-b, UE 115-b may determine if UE 115-b is in the same network (e.g., core network, such as a 5G network) as it was before going OOS. In some cases, UE 115-b may check the timer to determine if the network remained the same. For example, UE 115-b may start a timer with a configured duration at 360, and UE 115-b may check the timer at 370. UE 115-b may determine that it may have re-acquired service with the same network cell after going OOS according to the timer. For example, UE 115-b may have remained in the same network if UE 115-b re-acquired service with the network before the expiration of the timer. Additionally or alternatively, UE 115-b may determine that the network remained the same by checking the network identification information received in the registration acceptance message at 315. For example, UE 115-b may compare an AMF ID and/or a registration area code received at 315 in the first registration acceptance message with an AMF ID and/or a registration area code received at 365 in the second registration acceptance message. If the network information is the same, UE 115-b may determine that it may be in the same core network.

At 370, in some cases, UE 115-b may determine that it is not in the same network cell after going OOS. For example, UE 115-b may determine that the timer may have expired and/or the network identification information received at 365 may be different from the network identification information received at 315.

In such cases, at 375, UE 115-b may re-start the session establishment procedure. For example, UE 115-b may re-attempt to establish a data session with the network at 325 by transmitting a session request message including the first RSD again. In some cases, UE 115-b may cycle through each RSD of the set of RSDs stored at UE 115-b again until a session accept message from AMF 305 may be received. In this case, UE 115-b may not use a stored RSD that was previously accepted by AMF 305, and UE 115-b may instead sequentially select different RSDs based on the core network changing while UE 115-b was OOS.

Additionally or alternatively, at 370, UE 115-b may determine that it remained in the same network after going OOS. In such cases, UE 115-b may not restart the session establishment procedure at 375. Here, UE 115-b may transmit a session request message to AMF 305 at 380, where the session request message may include the accepted RSD stored in a memory cell of UE 115-b (e.g., at 355). UE 115-b may transmit the session request message including the accepted RSD according to a determination at 370 that UE 115-b remained in the same network. In such cases, UE 115-b may avoid multiple session establishment requests using RSDs that may have been previously rejected, and UE 115-b may instead utilize the RSD which is known to have been accepted by AMF 305 prior to going OOS. Thus, UE 115-b may efficiently reestablish a data session with a core network for the same application and/or subscription with minimal or reduced latency (e.g., as compared to using one or more RSDs that may have been previously rejected), thereby increasing reliability and enhancing user experience.

At 385, AMF 305 may select UPF 310-b for traffic routing functions according to one or more of the components associated with the accepted RSD. In some examples, the RSD may map to UPF 310-b. Additionally or alternatively, AMF 305 may select UPF 310-b according to the session response message including the same RSD transmitted at 340, the selection of UPF 310-b at 345, and/or according to the session accept message transmitted at 350.

At 390, AMF 305 may transmit a session accept message to UE 115-b. The session accept message may indicate that the accepted RSD may be compatible with the network. In some implementations, the session accept message may be the same as the session accept message transmitted at 350. In some aspects, storing the accepted RSD in a memory cell of UE 115-b at 355 may improve the session establishment procedure between UE 115-b and the network after UE 115-b re-acquires service with the network, (e.g., the session request message transmitted at 380, the UPF 310-b selection at 385, and the session accept message transmitted at 390). For example, the session establishment procedure may be completed more efficiently and/or more reliably, and may include fewer transmissions because UE 115-b may use the accepted RSD, which may have been stored in a memory cell of UE 115-b at 355.

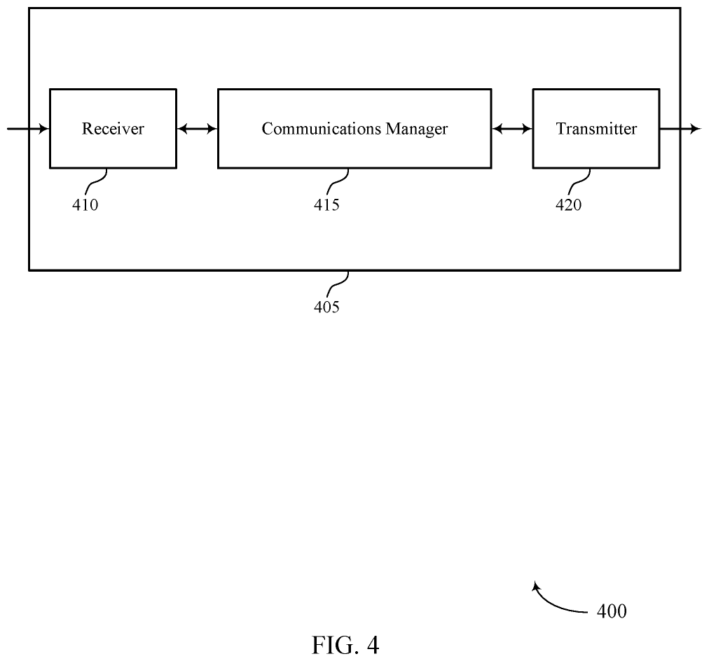

FIG. 4 shows a block diagram 400 of a device 405 that supports techniques for accelerating data recovery from out of service in accordance with aspects of the present disclosure. The device 405 may be an example of aspects of a UE 115 as described herein. The device 405 may include a receiver 410, a communications manager 415, and a transmitter 420. The device 405 may also include a processor. Each of these components may be in communication with one another (e.g., via one or more buses).

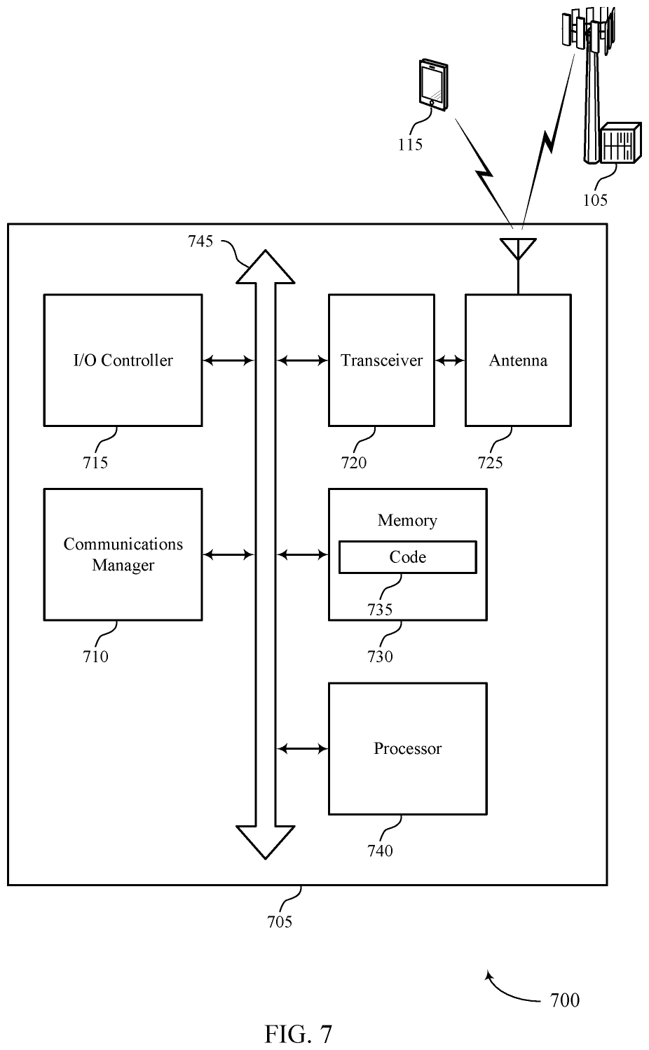

The receiver 410 may receive information such as packets, user data, or control information associated with various information channels (e.g., control channels, data channels, and information related to techniques for accelerating data recovery from out of service, etc.). Information may be passed on to other components of the device 405. The receiver 410 may be an example of aspects of the transceiver 720 described with reference to FIG. 7. The receiver 410 may utilize a single antenna or a set of antennas.

The communications manager 415 may transmit a first session establishment request message to a cell, the first session establishment request message indicating a first RSD from a set of RSDs, receive, in response to the first session establishment request message, a session establishment accept message from the cell based on an acceptance of the first RSD, transmit, after going out of service with the cell, a second session establishment request message to the cell, the second session establishment request message indicating the stored first RSD, where the second session establishment request message is transmitted based on reacquiring service with the cell, and store the first RSD based on the received session establishment accept message. The communications manager 415 may be an example of aspects of the communications manager 710 described herein.

The communications manager 415, or its sub-components, may be implemented in hardware, code (e.g., software or firmware) executed by a processor, or any combination thereof. If implemented in code executed by a processor, the functions of the communications manager 415, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 415, or its sub-components, may be physically located at various positions, including being distributed such that portions of functions are implemented at different physical locations by one or more physical components. In some examples, the communications manager 415, or its sub-components, may be a separate and distinct component in accordance with various aspects of the present disclosure. In some examples, the communications manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 420 may transmit signals generated by other components of the device 405. In some examples, the transmitter 420 may be collocated with a receiver 410 in a transceiver module. For example, the transmitter 420 may be an example of aspects of the transceiver 720 described with reference to FIG. 7. The transmitter 420 may utilize a single antenna or a set of antennas.

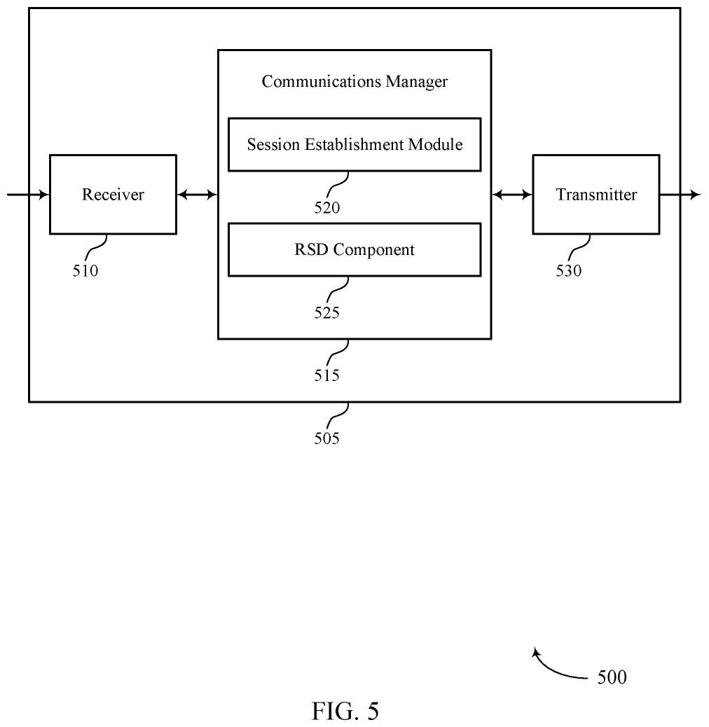

FIG. 5 shows a block diagram 500 of a device 505 that supports techniques for accelerating data recovery from out of service in accordance with aspects of the present disclosure. The device 505 may be an example of aspects of a device 405, or a UE 115 as described herein. The device 505 may include a receiver 510, a communications manager 515, and a transmitter 530. The device 505 may also include a processor. Each of these components may be in communication with one another (e.g., via one or more buses).

The receiver 510 may receive information such as packets, user data, or control information associated with various information channels (e.g., control channels, data channels, and information related to techniques for accelerating data recovery from out of service, etc.). Information may be passed on to other components of the device 505. The receiver 510 may be an example of aspects of the transceiver 720 described with reference to FIG. 7. The receiver 510 may utilize a single antenna or a set of antennas.

The communications manager 515 may be an example of aspects of the communications manager 415 as described herein. The communications manager 515 may include a session establishment module 520 and an RSD component 525. The communications manager 515 may be an example of aspects of the communications manager 710 described herein.

The session establishment module 520 may transmit a first session establishment request message to a cell, the first session establishment request message indicating a first RSD from a set of RSDs. In some examples, the session establishment module 520 may receive, in response to the first session establishment request message, a session establishment accept message from the cell based on an acceptance of the first RSD. In some examples, session establishment module 520 may transmit, after going out of service with the cell, a second session establishment request message to the cell, the second session establishment request message indicating the stored first RSD, where the second session establishment request message is transmitted based on reacquiring service with the cell. The RSD component 525 may store the first RSD based on the received session establishment accept message.

The transmitter 530 may transmit signals generated by other components of the device 505. In some examples, the transmitter 530 may be collocated with a receiver 510 in a transceiver module. For example, the transmitter 530 may be an example of aspects of the transceiver 720 described with reference to FIG. 7. The transmitter 530 may utilize a single antenna or a set of antennas.

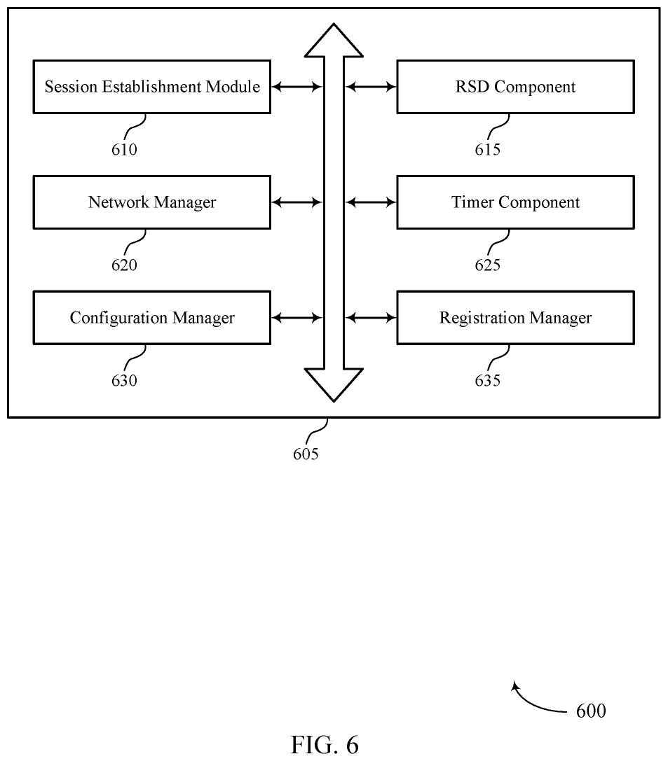

FIG. 6 shows a block diagram 600 of a communications manager 605 that supports techniques for accelerating data recovery from out of service in accordance with aspects of the present disclosure. The communications manager 605 may be an example of aspects of a communications manager 415, a communications manager 515, or a communications manager 710 described herein. The communications manager 605 may include a session establishment module 610, an RSD component 615, a network manager 620, a timer component 625, a configuration manager 630, and a registration manager 635. Each of these modules may communicate, directly or indirectly, with one another (e.g., via one or more buses).

The session establishment module 610 may transmit a first session establishment request message to a cell, the first session establishment request message indicating a first RSD from a set of RSDs. In some examples, the session establishment module 610 may receive, in response to the first session establishment request message, a session establishment accept message from the cell based on an acceptance of the first RSD.

In some examples, the session establishment module 610 may transmit, after going out of service with the cell, a second session establishment request message to the cell, the second session establishment request message indicating the stored first RSD, where the second session establishment request message is transmitted based on reacquiring service with the cell.

In some examples, the session establishment module 610 may transmit a third session establishment request message indicating a second RSD from the set of RSDs, the second RSD being different from the first RSD.

In some examples, the session establishment module 610 may transmit, prior to the first session establishment request message, one or more session establishment request messages, each session establishment request message of the one or more session establishment request messages indicating another RSD from the set of RSDs that is different from the first RSD.

In some examples, the session establishment module 610 may receive, in response to each session establishment request message of the one or more session establishment request messages, a session establishment rejection messages based on the other RSDs. In some cases, the first session establishment request message and the second session establishment request message are for a same application, a same subscription, or both. In some cases, the first session establishment request message and the second session establishment request message include a PDU session establishment request message.

The RSD component 615 may store the first RSD based on the received session establishment accept message. In some cases, the first RSD includes an RSD precedence, route selection components, a session and service continuity mode selection, network slice selection assistance information, a data network name selection, a PDU session type selection, a non-seamless offload indication, an access type preference, or any combination thereof.

The network manager 620 may determine whether a core network remains the same when reacquiring service with the cell, where transmitting the second session establishment request message indicating the stored first RSD is based on a determination that the core network is the same when service is reacquired. In some examples, the network manager 620 may determine whether the core network remains the same based on an expiration of the timer.

In some examples, the network manager 620 may determine that the core network remains the same based on service being reacquired prior to the expiration of the timer, where the second session establishment request message indicating the stored first RSD is transmitted prior to the expiration of the timer. In some examples, the network manager 620 may determine that the core network has changed based on service being reacquired after the expiration of the timer.

The timer component 625 may start a timer based on storing the first RSD. The configuration manager 630 may determine a configuration of the timer, where a duration of the timer is based on the configuration. In some cases, the configuration is based on an operator deployment for the core network.

The registration manager 635 may identify, prior to going out of service with the cell, a first registration area code and a first node identifier associated with a first network node. In some examples, the registration manager 635 may receive, when reacquiring service with the cell, a registration acceptance message that includes an indication of a second registration area code and a second node identifier, where determining that the core network remains the same is based on the first registration area code being the same as the second registration area code and the first node identifier being the same as the second node identifier.

FIG. 7 shows a diagram of a system 700 including a device 705 that supports techniques for accelerating data recovery from out of service in accordance with aspects of the present disclosure. The device 705 may be an example of or include the components of device 405, device 505, or a UE 115 as described herein. The device 705 may include components for bi-directional voice and data communications including components for transmitting and receiving communications, including a communications manager 710, an I/O controller 715, a transceiver 720, an antenna 725, memory 730, and a processor 740. These components may be in electronic communication via one or more buses (e.g., bus 745).

The communications manager 710 may transmit a first session establishment request message to a cell, the first session establishment request message indicating a first RSD from a set of RSDs, receive, in response to the first session establishment request message, a session establishment accept message from the cell based on an acceptance of the first RSD, transmit, after going out of service with the cell, a second session establishment request message to the cell, the second session establishment request message indicating the stored first RSD, where the second session establishment request message is transmitted based on reacquiring service with the cell, and store the first RSD based on the received session establishment accept message.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas. In some cases, the wireless device may include a single antenna 725. However, in some cases the device may have more than one antenna 725, which may be capable of concurrently transmitting or receiving multiple wireless transmissions.

The memory 730 may include random access memory (RAM) and read-only memory (ROM). The memory 730 may store computer-readable, computer-executable code 735 including instructions that, when executed, cause the processor to perform various functions described herein. In some cases, the memory 730 may contain, among other things, a basic input/output system (BIOS) which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for accelerating data recovery from out of service).

The code 735 may include instructions to implement aspects of the present disclosure, including instructions to support wireless communications. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

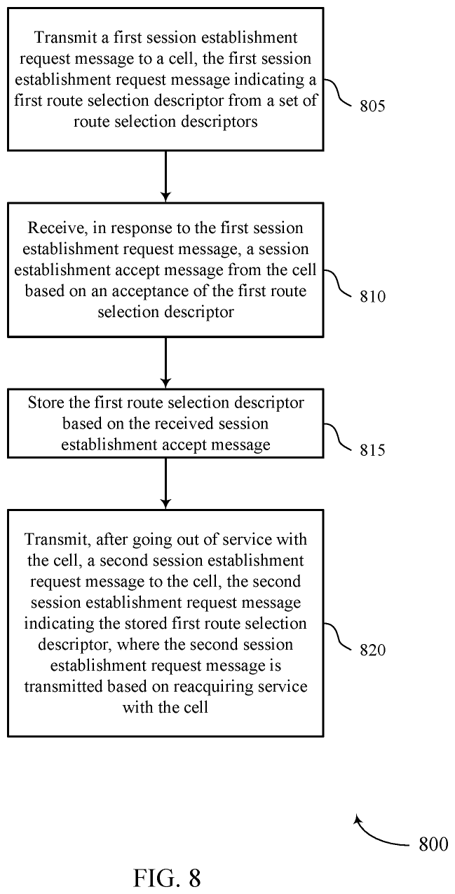

FIG. 8 shows a flowchart illustrating a method 800 that supports techniques for accelerating data recovery from out of service in accordance with aspects of the present disclosure. The operations of method 800 may be implemented by a UE 115 or its components as described herein. For example, the operations of method 800 may be performed by a communications manager as described with reference to FIGS. 4 through 7. In some examples, a UE may execute a set of instructions to control the functional elements of the UE to perform the functions described below. Additionally or alternatively, a UE may perform aspects of the functions described below using special-purpose hardware.

At 805, the UE may transmit a first session establishment request message to a cell, the first session establishment request message indicating a first RSD from a set of RSDs. The operations of 805 may be performed according to the methods described herein. In some examples, aspects of the operations of 805 may be performed by a session establishment module as described with reference to FIGS. 4 through 7.

At 810, the UE may receive, in response to the first session establishment request message, a session establishment accept message from the cell based on an acceptance of the first RSD. The operations of 810 may be performed according to the methods described herein. In some examples, aspects of the operations of 810 may be performed by a session establishment module as described with reference to FIGS. 4 through 7.

At 815, the UE may store the first RSD based on the received session establishment accept message. The operations of 815 may be performed according to the methods described herein. In some examples, aspects of the operations of 815 may be performed by an RSD component as described with reference to FIGS. 4 through 7.

At 820, the UE may transmit, after going out of service with the cell, a second session establishment request message to the cell, the second session establishment request message indicating the stored first RSD, where the second session establishment request message is transmitted based on reacquiring service with the cell. The operations of 820 may be performed according to the methods described herein. In some examples, aspects of the operations of 820 may be performed by a session establishment module as described with reference to FIGS. 4 through 7.

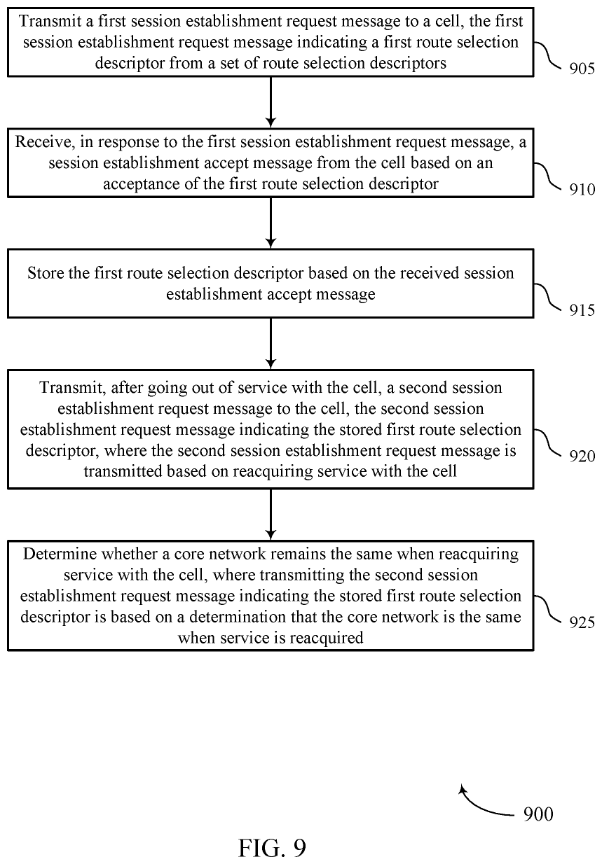

FIG. 9 shows a flowchart illustrating a method 900 that supports techniques for accelerating data recovery from out of service in accordance with aspects of the present disclosure. The operations of method 900 may be implemented by a UE 115 or its components as described herein. For example, the operations of method 900 may be performed by a communications manager as described with reference to FIGS. 4 through 7. In some examples, a UE may execute a set of instructions to control the functional elements of the UE to perform the functions described below. Additionally or alternatively, a UE may perform aspects of the functions described below using special-purpose hardware.

At 905, the UE may transmit a first session establishment request message to a cell, the first session establishment request message indicating a first RSD from a set of RSDs. The operations of 905 may be performed according to the methods described herein. In some examples, aspects of the operations of 905 may be performed by a session establishment module as described with reference to FIGS. 4 through 7.

At 910, the UE may receive, in response to the first session establishment request message, a session establishment accept message from the cell based on an acceptance of the first RSD. The operations of 910 may be performed according to the methods described herein. In some examples, aspects of the operations of 910 may be performed by a session establishment module as described with reference to FIGS. 4 through 7.

At 915, the UE may store the first RSD based on the received session establishment accept message. The operations of 915 may be performed according to the methods described herein. In some examples, aspects of the operations of 915 may be performed by an RSD component as described with reference to FIGS. 4 through 7.

At 920, the UE may transmit, after going out of service with the cell, a second session establishment request message to the cell, the second session establishment request message indicating the stored first RSD, where the second session establishment request message is transmitted based on reacquiring service with the cell. The operations of 920 may be performed according to the methods described herein. In some examples, aspects of the operations of 920 may be performed by a session establishment module as described with reference to FIGS. 4 through 7.

At 925, the UE may determine whether a core network remains the same when reacquiring service with the cell, where transmitting the second session establishment request message indicating the stored first RSD is based on a determination that the core network is the same when service is reacquired. The operations of 925 may be performed according to the methods described herein. In some examples, aspects of the operations of 925 may be performed by a network manager as described with reference to FIGS. 4 through 7.

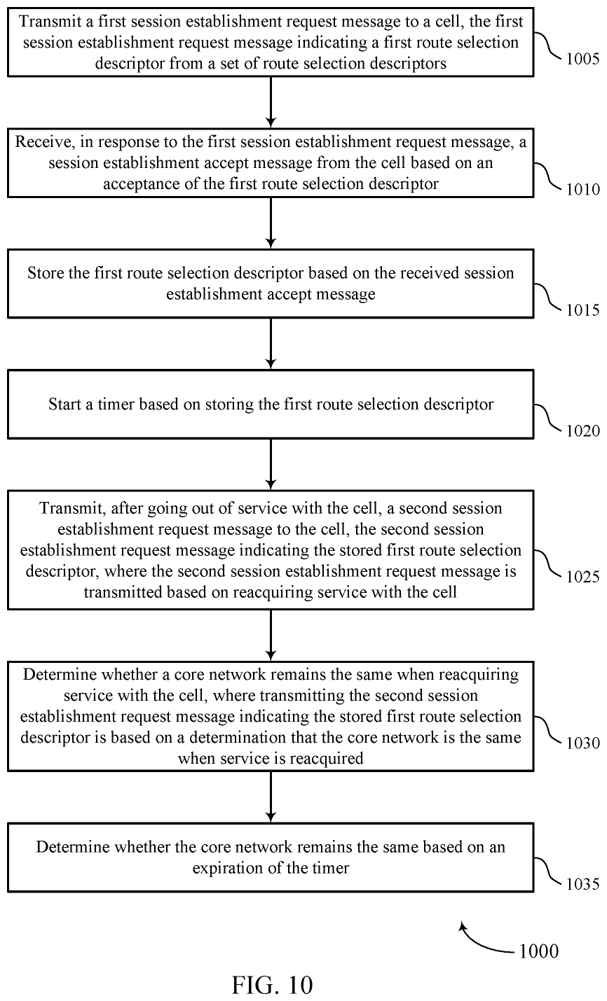

FIG. 10 shows a flowchart illustrating a method 1000 that supports techniques for accelerating data recovery from out of service in accordance with aspects of the present disclosure. The operations of method 1000 may be implemented by a UE 115 or its components as described herein. For example, the operations of method 1000 may be performed by a communications manager as described with reference to FIGS. 4 through 7. In some examples, a UE may execute a set of instructions to control the functional elements of the UE to perform the functions described below. Additionally or alternatively, a UE may perform aspects of the functions described below using special-purpose hardware.

At 1005, the UE may transmit a first session establishment request message to a cell, the first session establishment request message indicating a first RSD from a set of RSDs. The operations of 1005 may be performed according to the methods described herein. In some examples, aspects of the operations of 1005 may be performed by a session establishment module as described with reference to FIGS. 4 through 7.

At 1010, the UE may receive, in response to the first session establishment request message, a session establishment accept message from the cell based on an acceptance of the first RSD. The operations of 1010 may be performed according to the methods described herein. In some examples, aspects of the operations of 1010 may be performed by a session establishment module as described with reference to FIGS. 4 through 7.

At 1015, the UE may store the first RSD based on the received session establishment accept message. The operations of 1015 may be performed according to the methods described herein. In some examples, aspects of the operations of 1015 may be performed by an RSD component as described with reference to FIGS. 4 through 7.

At 1020, the UE may start a timer based on storing the first RSD. The operations of 1020 may be performed according to the methods described herein. In some examples, aspects of the operations of 1020 may be performed by a timer component as described with reference to FIGS. 4 through 7.

At 1025, the UE may transmit, after going out of service with the cell, a second session establishment request message to the cell, the second session establishment request message indicating the stored first RSD, where the second session establishment request message is transmitted based on reacquiring service with the cell. The operations of 1025 may be performed according to the methods described herein. In some examples, aspects of the operations of 1025 may be performed by a session establishment module as described with reference to FIGS. 4 through 7.

At 1030, the UE may determine whether a core network remains the same when reacquiring service with the cell, where transmitting the second session establishment request message indicating the stored first RSD is based on a determination that the core network is the same when service is reacquired. The operations of 1030 may be performed according to the methods described herein. In some examples, aspects of the operations of 1030 may be performed by a network manager as described with reference to FIGS. 4 through 7.

At 1035, the UE may determine whether the core network remains the same based on an expiration of the timer. The operations of 1035 may be performed according to the methods described herein. In some examples, aspects of the operations of 1035 may be performed by a network manager as described with reference to FIGS. 4 through 7.

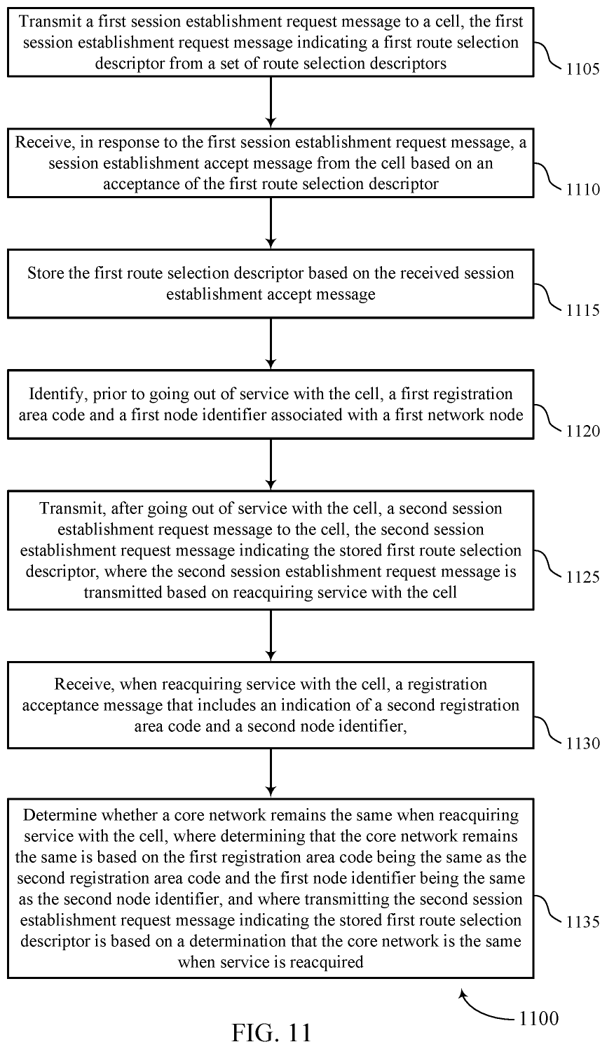

FIG. 11 shows a flowchart illustrating a method 1100 that supports techniques for accelerating data recovery from out of service in accordance with aspects of the present disclosure. The operations of method 1100 may be implemented by a UE 115 or its components as described herein. For example, the operations of method 1100 may be performed by a communications manager as described with reference to FIGS. 4 through 7. In some examples, a UE may execute a set of instructions to control the functional elements of the UE to perform the functions described below. Additionally or alternatively, a UE may perform aspects of the functions described below using special-purpose hardware.

At 1105, the UE may transmit a first session establishment request message to a cell, the first session establishment request message indicating a first RSD from a set of RSDs. The operations of 1105 may be performed according to the methods described herein. In some examples, aspects of the operations of 1105 may be performed by a session establishment module as described with reference to FIGS. 4 through 7.

At 1110, the UE may receive, in response to the first session establishment request message, a session establishment accept message from the cell based on an acceptance of the first RSD. The operations of 1110 may be performed according to the methods described herein. In some examples, aspects of the operations of 1110 may be performed by a session establishment module as described with reference to FIGS. 4 through 7.

At 1115, the UE may store the first RSD based on the received session establishment accept message. The operations of 1115 may be performed according to the methods described herein. In some examples, aspects of the operations of 1115 may be performed by an RSD component as described with reference to FIGS. 4 through 7.

At 1120, the UE may identify, prior to going out of service with the cell, a first registration area code and a first node identifier associated with a first network node. The operations of 1120 may be performed according to the methods described herein. In some examples, aspects of the operations of 1120 may be performed by a registration manager as described with reference to FIGS. 4 through 7.

At 1125, the UE may transmit, after going out of service with the cell, a second session establishment request message to the cell, the second session establishment request message indicating the stored first RSD, where the second session establishment request message is transmitted based on reacquiring service with the cell. The operations of 1125 may be performed according to the methods described herein. In some examples, aspects of the operations of 1125 may be performed by a session establishment module as described with reference to FIGS. 4 through 7.

At 1130, the UE may receive, when reacquiring service with the cell, a registration acceptance message that includes an indication of a second registration area code and a second node identifier. The operations of 1130 may be performed according to the methods described herein. In some examples, aspects of the operations of 1130 may be performed by a registration manager as described with reference to FIGS. 4 through 7.

At 1135, the UE may determine whether a core network remains the same when reacquiring service with the cell, where determining that the core network remains the same is based on the first registration area code being the same as the second registration area code and the first node identifier being the same as the second node identifier, and where transmitting the second session establishment request message indicating the stored first RSD is based on a determination that the core network is the same when service is reacquired. The operations of 1135 may be performed according to the methods described herein. In some examples, aspects of the operations of 1135 may be performed by a network manager as described with reference to FIGS. 4 through 7.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. An apparatus for wireless communication at a user equipment (UE), comprising:
a processor,
memory coupled with the processor; and
instructions stored in the memory and executable by the processor to cause the apparatus to:
transmit a first session establishment request message to a cell, the first session establishment request message indicating a route selection descriptor from a set of route selection descriptors;
receive, in response to the first session establishment request message, a session establishment accept message from the cell based at least in part on an acceptance of the route selection descriptor;
store the route selection descriptor based at least in part on the received session establishment accept message; and
transmit, after going out of service with the cell, a second session establishment request message to the cell, the second session establishment request message indicating the stored route selection descriptor, wherein the second session establishment request message is transmitted based at least in part on reacquiring service with the cell.

2. The apparatus of claim 1, wherein the instructions are further executable by the processor to cause the apparatus to:
determine whether a core network remains the same when reacquiring service with the cell, wherein transmitting the second session establishment request message indicating the stored route selection descriptor is based at least in part on a determination that the core network is the same when service is reacquired.

3. The apparatus of claim 2, wherein the instructions are further executable by the processor to cause the apparatus to:
start a timer based at least in part on storing the route selection descriptor; and
determine whether the core network remains the same based at least in part on an expiration of the timer.

4. The apparatus of claim 3, wherein the instructions are further executable by the processor to cause the apparatus to:
determine that the core network remains the same based at least in part on service being reacquired prior to the expiration of the timer, wherein the second session establishment request message indicating the stored route selection descriptor is transmitted prior to the expiration of the timer.

5. The apparatus of claim 3, wherein the instructions are further executable by the processor to cause the apparatus to:
determine that the core network has changed based at least in part on service being reacquired after the expiration of the timer; and
transmit a third session establishment request message indicating a second route selection descriptor from the set of route selection descriptors, the second route selection descriptor being different from the route selection descriptor.

6. The apparatus of claim 3, wherein the instructions are further executable by the processor to cause the apparatus to:
determine a configuration of the timer, wherein a duration of the timer is based at least in part on the configuration.

7. The apparatus of claim 6, wherein the configuration is based at least in part on an operator deployment for the core network.

8. The apparatus of claim 2, wherein the instructions are further executable by the processor to cause the apparatus to:
identify, prior to going out of service with the cell, a first registration area code and a first node identifier associated with a first network node; and
receive, when reacquiring service with the cell, a registration acceptance message that includes an indication of a second registration area code and a second node identifier,
wherein determining that the core network remains the same is based at least in part on the first registration area code being the same as the second registration area code and the first node identifier being the same as the second node identifier.

9. The apparatus of claim 1, wherein the first session establishment request message and the second session establishment request message are for a same application, a same subscription, or both.

10. The apparatus of claim 1, wherein the instructions are further executable by the processor to cause the apparatus to:
transmit, prior to the first session establishment request message, one or more session establishment request messages, each session establishment request message of the one or more session establishment request messages indicating another route selection descriptor from the set of route selection descriptors that is different from the route selection descriptor; and
receive, in response to each session establishment request message of the one or more session establishment request messages, a session establishment rejection messages based at least in part on the other route selection descriptor.

11. The apparatus of claim 1, wherein the route selection descriptor comprises a route selection descriptor precedence, route selection components, a session and service continuity mode selection, network slice selection assistance information, a data network name selection, a protocol data unit session type selection, a non-seamless offload indication, an access type preference, or any combination thereof.

12. The apparatus of claim 1, wherein the first session establishment request message and the second session establishment request message comprise a protocol data unit session establishment request message.

13. A method for wireless communication at a user equipment (UE), comprising:
transmitting a first session establishment request message to a cell, the first session establishment request message indicating a route selection descriptor from a set of route selection descriptors;
receiving, in response to the first session establishment request message, a session establishment accept message from the cell based at least in part on an acceptance of the route selection descriptor;
storing the route selection descriptor based at least in part on the received session establishment accept message; and
transmitting, after going out of service with the cell, a second session establishment request message to the cell, the second session establishment request message indicating the stored route selection descriptor, wherein the second session establishment request message is transmitted based at least in part on reacquiring service with the cell.

14. The method of claim 13, further comprising:
determining whether a core network remains the same when reacquiring service with the cell, wherein transmitting the second session establishment request message indicating the stored route selection descriptor is based at least in part on a determination that the core network is the same when service is reacquired.

15. The method of claim 14, further comprising:
starting a timer based at least in part on storing the route selection descriptor; and
determining whether the core network remains the same based at least in part on an expiration of the timer.

16. The method of claim 15, further comprising:
determining that the core network remains the same based at least in part on service being reacquired prior to the expiration of the timer, wherein the second session establishment request message indicating the stored route selection descriptor is transmitted prior to the expiration of the timer.

17. The method of claim 15, further comprising:
determining that the core network has changed based at least in part on service being reacquired after the expiration of the timer; and
transmitting a third session establishment request message indicating a second route selection descriptor from the set of route selection descriptors, the second route selection descriptor being different from the route selection descriptor.

18. The method of claim 15, further comprising:
determining a configuration of the timer, wherein a duration of the timer is based at least in part on the configuration.

19. The method of claim 18, wherein the configuration is based at least in part on an operator deployment for the core network.

20. The method of claim 14, further comprising:
identifying, prior to going out of service with the cell, a first registration area code and a first node identifier associated with a first network node; and
receiving, when reacquiring service with the cell, a registration acceptance message that includes an indication of a second registration area code and a second node identifier, wherein determining that the core network remains the same is based at least in part on the first registration area code being the same as the second registration area code and the first node identifier being the same as the second node identifier.

21. The method of claim 13, wherein the first session establishment request message and the second session establishment request message are for a same application, a same subscription, or both.

22. The method of claim 13, further comprising:
transmitting, prior to the first session establishment request message, one or more session establishment request messages, each session establishment request message of the one or more session establishment request messages indicating another route selection descriptor from the set of route selection descriptors that is different from the route selection descriptor; and
receiving, in response to each session establishment request message of the one or more session establishment request messages, a session establishment rejection messages based at least in part on the other route selection descriptor.

23. The method of claim 13, wherein the route selection descriptor comprises a route selection descriptor precedence, route selection components, a session and service continuity mode selection, network slice selection assistance information, a data network name selection, a protocol data unit session type selection, a non-seamless offload indication, an access type preference, or any combination thereof.

24. The method of claim 13, wherein the first session establishment request message and the second session establishment request message comprise a protocol data unit session establishment request message.

25. An apparatus for wireless communication at a user equipment (UE), comprising:
means for transmitting a first session establishment request message to a cell, the first session establishment request message indicating a route selection descriptor from a set of route selection descriptors;
means for receiving, in response to the first session establishment request message, a session establishment accept message from the cell based at least in part on an acceptance of the route selection descriptor;
means for storing the route selection descriptor based at least in part on the received session establishment accept message; and
means for transmitting, after going out of service with the cell, a second session establishment request message to the cell, the second session establishment request message indicating the stored route selection descriptor, wherein the second session establishment request message is transmitted based at least in part on reacquiring service with the cell.

26. The apparatus of claim 25, further comprising:
means for determining whether a core network remains the same when reacquiring service with the cell, wherein transmitting the second session establishment request message indicating the stored route selection descriptor is based at least in part on a determination that the core network is the same when service is reacquired.

27. The apparatus of claim 26, further comprising:
means for starting a timer based at least in part on storing the route selection descriptor; and
means for determining whether the core network remains the same based at least in part on an expiration of the timer.

28. The apparatus of claim 27, further comprising:
means for determining that the core network remains the same based at least in part on service being reacquired prior to the expiration of the timer, wherein the second session establishment request message indicating the stored route selection descriptor is transmitted prior to the expiration of the timer.

29. The apparatus of claim 27, further comprising:
means for determining that the core network has changed based at least in part on service being reacquired after the expiration of the timer; and
means for transmitting a third session establishment request message indicating a second route selection descriptor from the set of route selection descriptors, the second route selection descriptor being different from the route selection descriptor.

30. The apparatus of claim 27, further comprising:
means for determining a configuration of the timer, wherein a duration of the timer is based at least in part on the configuration.

31. The apparatus of claim 30, wherein the configuration is based at least in part on an operator deployment for the core network.

32. The apparatus of claim 26, further comprising:
means for identifying, prior to going out of service with the cell, a first registration area code and a first node identifier associated with a first network node; and
means for receiving, when reacquiring service with the cell, a registration acceptance message that includes an indication of a second registration area code and a second node identifier, wherein determining that the core network remains the same is based at least in part on the first registration area code being the same as the second registration area code and the first node identifier being the same as the second node identifier.

33-36. (canceled)

37. A non-transitory computer-readable medium storing code for wireless communication at a user equipment (UE), the code comprising instructions executable by a processor to:
transmit a first session establishment request message to a cell, the first session establishment request message indicating a route selection descriptor from a set of route selection descriptors;
receive, in response to the first session establishment request message, a session establishment accept message from the cell based at least in part on an acceptance of the route selection descriptor;
store the route selection descriptor based at least in part on the received session establishment accept message; and
transmit, after going out of service with the cell, a second session establishment request message to the cell, the second session establishment request message indicating the stored route selection descriptor, wherein the second session establishment request message is transmitted based at least in part on reacquiring service with the cell.

38. The non-transitory computer-readable medium of claim 37, wherein the instructions are further executable to:
determine whether a core network remains the same when reacquiring service with the cell, wherein transmitting the second session establishment request message indicating the stored route selection descriptor is based at least in part on a determination that the core network is the same when service is reacquired.

39. The non-transitory computer-readable medium of claim 38, wherein the instructions are further executable to:
start a timer based at least in part on storing the route selection descriptor; and
determine whether the core network remains the same based at least in part on an expiration of the timer.

40-48. (canceled)
